(19) United States
(12) Patent Application Publication
(10) Pub. No.: US 2014/0244499 A1
(43) Pub. Date: Aug. 28, 2014

(54) OFF-SHORE MONEY TRANSFER TRANSACTION SYSTEM AND METHOD

(71) Applicant: THE WESTERN UNION COMPANY, Englewood, CO (US)

(72) Inventor: Lance W. Gruner, Denver, CO (US)

(73) Assignee: THE WESTERN UNION COMPANY, Englewood, CO (US)

(21) Appl. No.: 13/777,733

(22) Filed: Feb. 26, 2013

(51) Int. Cl. G06Q 20/40

(52) U.S. Cl. CPC G06Q 20/4014
USPC 705/42

(57) ABSTRACT

Money transfer requests are received from a remote location (such as from an off-shore ship). Enhanced security is provided by receiving, as part of a money transfer request, a device ID of an off-shore POS device at the remote location used to transmit the money transfer request and path IDs of one or more points in the path over the Internet that the message uses to reach a money transfer host. The device ID and path IDs are compared to data received in advance that specifies the IDs of an authorized device and authorized path.

### BACKGROUND OF THE INVENTION

Money transfer services are widely used to transfer money and pay bills through the use of wire transfers, money orders and the like. Unlike bank account transfers, very little personal information or transaction history concerning the sender and recipient (other than identification information) is typically provided at the time of the transaction. As a result, attempts are sometimes made to use money transfers for illegal and other improper purposes, such as money laundering, payment for illicit products or services, and funding terrorist or other criminal activity.

Methods have been developed to prevent improper use of money transfers, such as creating lists of senders, recipients, and countries where suspicious activity has been reported. For example, the name of a person known to be associated with money laundering may be added to a “black list,” so that any future transaction to/from the same person may be flagged for review and possible rejection. In some cases, where certain countries or other geographical locations have been known to involve higher risk of illegal activity, money transfers to or from such locations can be restricted or rejected, e.g., if the amount of the transaction exceeds a specified amount. In addition, when a transaction is conducted on-line by a sender (e.g., over the Internet using a website operated by a money transfer service), systems may also attempt to determine the source of the funds being used by a sender (by checking the history or pattern of money deposited to the account that is used by the sender to provide funds for the transfer). Thus, in order to satisfy the internal security measures of a money transfer service and also to comply with government regulations, it is useful for an on-line money transfer service to get reliable data on the sender, on the location where the transaction is being conducted, and on the source of funds used for the transaction.

Permitting on-line money transfers from remote locations outside typical jurisdictional boundaries (e.g., by crew members on a cruise ship) are particularly difficult to evaluate for fraud, given that, among other things, (1) the transactions are conducted at point-of-sale devices in locations not easily identified, (2) the senders (crew members) may be of many nationalities, and (3) the source of money used to fund the transfer (particularly for non-US accounts) is difficult to determine. As a result, crew members (and other senders) at remote locations receiving pay or salary have limited ability to transfer money while off shore.

### BRIEF SUMMARY OF THE INVENTION

There is provided, in accordance with embodiments of the present invention, a network/system and method for performing on-line money transfers from a remote location, such as by ship crew members while off-shore.

In one embodiment, a method (and corresponding system) is provided for conducting an on-line money transfer that is requested at a remote location. The method includes receiving, in advance of a money transfer request, data relating to money transfers at the remote location, the received data including at least a device ID that identifies a user device at the remote location, and a path ID that identifies one or more points in a path through which a message requesting a money transfer is to be electronically communicated from the remote location. The method further includes storing the device ID and the path ID received in advance of a money transfer request. A money transfer host computer receives a transmitted message from the remote location requesting a money transfer, the transmitted message including at least a transmitted device ID of a user device at which the money transfer is requested and a transmitted path ID of one or more points in a path through which the transmitted message passes from the user device to the money transfer host computer. The method further includes comparing the transmitted device ID and transmitted path ID to the stored device ID and stored path ID, and processing the received money transfer request if the stored device ID and stored path ID match the transmitted device ID and transmitted path ID.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram illustrating a system for conducting money transfer transactions from a sender at a remote, off-shore location.

FIG. 2 is a flow diagram illustrating the basic steps of a process for transferring money from a sender at a remote location, in accordance with an embodiment of the invention.

FIG. 3 is a flow diagram illustrating a more detailed process for transferring money from a sender at a remote location.

FIG. 4 illustrates portions of a money transfer request message transmitted from a remote location.

FIG. 5 is a block diagram of a computer system upon which various devices/systems illustrated in FIG. 1 may be implemented

### DETAILED DESCRIPTION OF THE INVENTION

Generally speaking, embodiments of the present invention provide methods and systems for processing on-line money transfers from remote locations, by configuring a money transfer system to collect (in advance) data on potential senders, data on the accounts to be used by the senders (e.g., accounts funded by a trusted source, such as an employer, and from which money is withdrawn for the money transfer), and data on the location where the money transfer is being requested. In one embodiment, the location may be established by identifying a remote user device at which a transaction may be conducted by a sender and identifying points in a data path (e.g., over the Internet) in which a money transfer request message may be transmitted by the user device. When a money transfer is conducted by one of the potential senders, the data collected in advance (relating to sender identification, device identification and path identification) is compared to corresponding data captured in the message from the sender requesting the money transfer.

While described embodiments relate to processing money transfer requests from employees that are off-shore and outside normal jurisdictional boundaries (e.g., crew members on a ship), it should be appreciated that broader aspects of the invention apply generally to money transfers requests from any remote location (e.g., a location where there is no agent present).

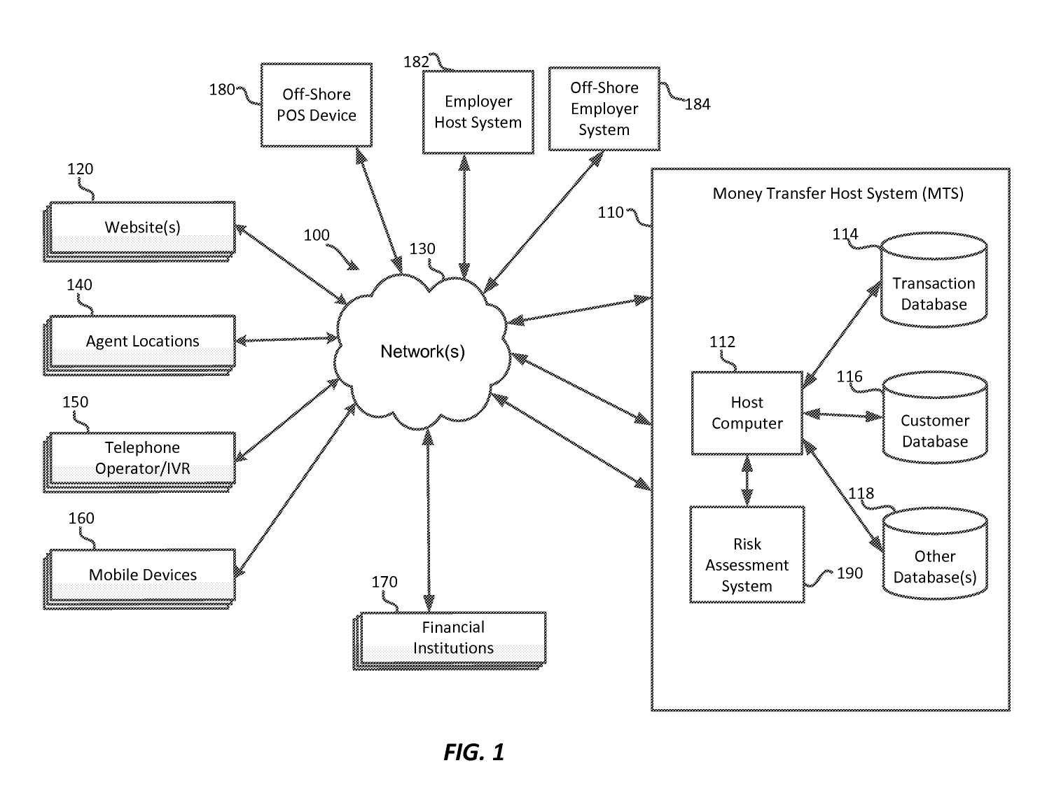

To better understand the invention through the description of a specific implementation, reference is made to FIG. 1, which is a block diagram illustrating a simplified embodiment of a money transfer system or network 100. The money transfer system may be operated by a money transfer entity or service provider, such as WESTERN UNION, and may be capable of performing a variety of consumer-based money transfer transactions from payors (senders) to payees (recipients). For example, money transfer network 100 may be capable of performing wire transfers and bill payment transactions. A wire transfer may be made from one party to another party, and may involve cash being transferred. Money transfer network 100 may include one or more websites 120, one or more agent locations 140, telephone operator and/or interactive voice response (IVR) systems 150, mobile devices 160, and a money transfer server or host system (MTS) 110.

Websites 120 are particularly useful in described embodiments of the invention, and allow payors and payees to conduct money transfer transactions at a remote location via the Internet and without having to visit an agent location. A payor may provide payment and transaction information to money transfer system 110 via website 120. For example, a payor may provide bank account information or credit card account information to money transfer system 110 via website 120. The system 110 may access such accounts, maintained at one or more financial institutions 170 (e.g., banks, credit unions, savings and loan associations, and other institutions maintaining accounts), through one or more networks 130. Likewise, payees may receive payment from money transfer system 110 via website 120. For example, a payee may provide a bank account number for funds to be deposited at one of the financial institutions 170, via website 120 and network 130. Website 120 may also permit a payor or payee to determine the status of a money transfer transaction (e.g., pending, completed, funds picked-up, etc.).

While not necessarily used in described embodiments of the invention, a typical money transfer system, such as network 100, will also include agent locations 140, telephone operator/IVR systems 150, and mobile devices 160.

Agent locations 140 may represent various kiosks and/or other physical agent locations where payors and payees may conduct money transfer transactions. For example, WESTERN UNION has hundreds of thousands of agent or money market transfer locations worldwide. At agent locations 140, a person, such as a clerk, may serve as a representative of the entity providing the money transfer service. Payors and payees may conduct money transfer transactions by interacting directly with an agent of the money transfer entity at the agent location.

Telephone operator and/or IVR system 150 allow a payor and/or payee to conduct the money transfer transaction via a telephone call to the telephone operator and/or IVR system 150. Payors and payees may provide the information necessary to conduct the money transfer transaction via the telephone, either to a human operator, or to an interactive voice response system. If a payor is conducting the money transfer using a bank account, credit card, stored value card, or using some other payment method besides cash, he may be able to conduct the entire transaction using the telephone operator and/or IVR system 150. Likewise, if the payee is receiving the funds via a method other than cash, he may be able to conduct the entire transaction using the telephone operator and/or IVR system 150.

Mobile devices 160 may represent various wireless devices that can communicate with money transfer system 110. For example, mobile device 160 may include cellular telephones, smart phones, handheld personal communication devices, laptops, tablet computers, etc. Mobile devices 160 may load a website 120 to interact with money transfer system 110. Alternatively, mobile devices 160 may run one or more pieces of software, such as applications or firmware configured to allow interaction with money transfer system 110. Via mobile devices 160, it may be possible for a payor to transmit funds to a payee. Also, it may be possible for a payee to receive funds via mobile devices 160.

In one embodiment described herein, the sender is a remotely-located employee (such as a crew member on a ship) that is located off-shore from where money transfers are normally conducted and regulated by a governmental entity. Employees (crew members) may use an off-shore kiosk or point-of-sale (POS) device 180 (e.g., placed on the ship by the employer/crew ship operator) to remotely access (via the Internet) one of the websites 120 in order to conduct a money transfer transaction. As will be more fully described later, in this embodiment employers may establish an account (such as, but not limited to, a checking/debit card account) for each employee in order to deposit paychecks or payroll amounts, and provide a card (such as a debit card) for accessing the account. An employee can thus use the debit card (and the underlying account) to fund a money transfer.

As will be described in greater detail later, in advance of the employee being able to use the POS device 180 for a money transfer request, the employer will provide information (via a data feed) for many if not all of its employees from an employer host system 182 to the money transfer host 110, such information including employee personal information (employee ID, name, address, nationality, etc.), and employee account information (account/card bin number) for the accounts in which employee paychecks are deposited. In one embodiment, once an employee is assigned to a remote location (e.g., to a ship on which a crew member/employee will be working off-shore), the employer will provide a second data feed from an off-shore employer system 184 (e.g., a system on the ship to which the crew member has been assigned) with additional information relevant to potential money transfers from that remote location, such as the employee IDs of assigned crew members, a device ID number (such as an IP address for the user/POS device 180 on the ship to be used for transactions), and IP address range or path data representing at least one point in the path that a message from the device 180 will use to send a money transfer request to the money transfer host 110. In an embodiment to also be described in greater detail later, the IP address range will represent the IP addresses assigned to each of the routers located at a satellite that has been set up to receive and route Internet messages transmitted from the ship/remote location to which the crew member/employee has been assigned. At least one of those router IP addresses (e.g., reflecting the specific router used at the satellite) will be appended to each message from the ship in order to provide a record of the path (or at least a portion of the path) used by the message to reach the money transfer host 110.

Websites 120, agent locations 140, telephone operator and/or IVR system 150, mobile devices 160, financial institutions 170, off-shore POS device 180, employer host system 182, and off-shore employer system 184 may communicate with money transfer host system 110 via the network 130. Network 130 is illustrated as a single network in FIG. 1. This is for ease of illustration only, since network 130 may include several networks. Further, the network used for agent locations 140 to communicate with money transfer host system 110 may be different from the network used by mobile devices 160 to communicate with money transfer host system 110. The network 130 may include one or more public networks, such as the Internet, and one or more private networks, such as a corporate intranet, a network operated by a banking system (for communications to and from financial institutions 170), and a network operated by a third party that links a number of agents that may each be affiliated with the third party (e.g., a company or organization, such as a retailer, that provides agents in locations where the system operator might otherwise not have agents). As briefly mentioned earlier (and as will be described more fully below), in one embodiment the off-shore POS device 180 and website 120 communicate with each other and with the money transfer host 110 via the Internet, using standard Internet protocols. The identity of the POS device 180 (reflected by its IP address) and the identity of a message path (reflected by the IP addresses of one or more routers or other points in the message path) can thus be used to identify the device being used for the money transfer request and also to track the path of the transfer request message (and hence determine the location of the POS device 180) as part of determining risk and authenticating data associated with a money transfer request.

Money transfer host system 110 may include one or more various subsystems used to complete a money transfer transaction. For example, the system 110 may include a host computer 112 that is configured to execute various software programs for managing money transfer transactions and for managing the communications with each of the websites 120, agent locations 140, telephone/IVR systems 150, mobile devices 160, financial institutions 170, off-shore POS device 180, employer host system 182, and off-shore employer system 184, as described above. The money transfer host system 110 also includes a transaction database 114, a customer database 116 and one or more other database(s) 118.

Transaction database 114 may store and manage information on pending and completed money transfer transactions. Transaction database 114 may include (but is not limited to) data identifying amounts of funds provided by payors, amounts of funds due to payees, payor names, addresses and phone numbers, payee names, addresses and phone numbers, transaction identifiers such as money transfer control numbers (MTCNs), the locations where the transactions were initiated (e.g., a website URL, an address of the agent location), the location of where the transaction is expected to be completed (e.g., where the payee is expected to receive the funds), the payor's payment method (e.g., cash, credit card, money order, stored value card, check, etc.), and whether or not various money transfer transactions have been completed or are pending.

Customer database 116 may store and manage biographical and identity information associated with the money transfer service provider's customers (e.g., existing customers, both payors and payees) and, in one embodiment, potential customers (employees that may in the future send money using an employer-established account). The stored data may include names, addresses, dates of birth, social security numbers, bank account numbers (including financial institution ID/routing numbers), and so forth. Among other things, database 116 may collect information that is needed in order to initiate a transaction (e.g., accessed by a customer ID in order to eliminate the need for the data to be separately entered each time an existing/registered customer conducts a transaction) and to also assess the risk associated with a transaction. In accordance with one embodiment, the database 116 may store and manage information downloaded from data feeds from the employer host system 182 and off-shore employer system 184, and in some cases store that information in database 114 when a transaction is being processed.

The other database(s) 118 store and manage information useful to the money transfer host in managing transactions and managing various administrative and operational tasks. As examples only, the other databases 118 may store information identifying or relating to each of the websites 120, to each of the off-shore POS devices 180, to each of the agents at agent locations 140, to each of the telephone/IVR systems 150 and to each of the mobile devices 160 that have been enabled to conduct transactions within network 100.

While databases 114, 116 and 118 are illustrated as separate databases for purposes of generally describing the data stored therein, it should be appreciated that such data could all be housed in a single database, or stored across a much larger number of databases, linked together at either a single location or across number of remote locations. Likewise, while the host computer 112 is illustrated as a single computer system or server, its functions could be performed by a plurality of computers or servers, linked together at either a single location or across a number of remote locations.

Also seen in FIG. 1 is a risk assessment system 190 that evaluates risk associated with senders and recipients and with each transaction being processed at the money transfer host system 110. The assessment or evaluation by the system 190 can be performed at various stages. As will be describe in greater detail later, a risk assessment may be performed based on an initial data feed from the employer host system 182 (assessing personal information for each employee before any transactions are conducted). It may also be performed on data received with a money transfer transaction request (e.g., based on the combined personal information of the sender and the recipient associated with the request and based on the amount being transferred). Various techniques can be used in assessing data associated with money transfer requests, examples of which can be found in co-pending and commonly assigned U.S. patent application Ser. No. 13/337,512 for Risk Analysis of Money Transfer Transactions, filed Dec. 27, 2011. While the risk assessment system 190 is illustrated as being part of the money transfer host system 110, it should be appreciated that, alternatively, it could be a separate system connected (directly or through networks 130) to the money transfer host system 110.

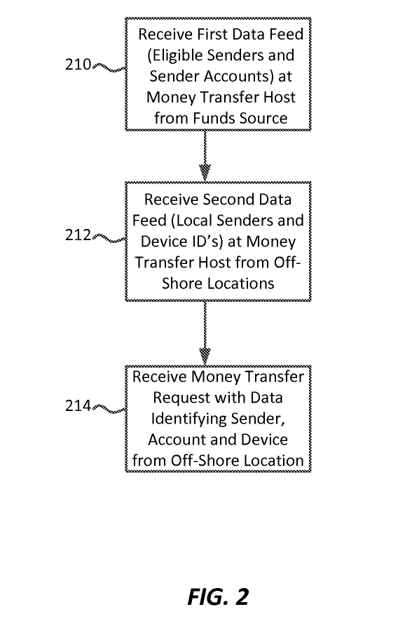

FIG. 2 is a flow diagram illustrating a simplified process having basic steps in one embodiment of the invention. One feature of the invention is collecting, in advance of money transfer requests, reliable data on the identity of a sender, data on an account to be used for funding money transfers (e.g., providing confidence that the funds are from a reliable/trusted/legitimate source), and data on the location where the money transfer is to be initiated (thus providing confidence that the location of the sender reflects lower or acceptable risk). Accordingly, at step 210 in FIG. 2 a first data feed is received at the money transfer host system 110 from the employer host system 182, the data feed relating to eligible or potential senders. In the described embodiment, the employer is the operator of a cruise ship, and the potential senders are employees/crew members of the ship operator. The crew members are paid through deposits into individual accounts established for the benefit of crew members by the ship operator. Those employer-establish accounts may be used by crew members to fund money transfers (among other things), and since the money deposited is from a trusted funds source (the employer), they can be safely regarded as not being from a suspect source (e.g., an entity using the funds for money laundering or other fraudulent purposes). In one specific embodiment, the employer/operator provides, in the first data feed for all of its employee/crew members (or at least those that may be assigned to a ship or other off-shore location), the following information for each employee:
Employee ID
Employee name
Employee address
Employee phone number
Employee nationality
BIN (Bank Identification Number) for the employee account/card
Last four digits of the employee account/card number
Employee email address

While step 210 illustrates a single data feed, it should be appreciated that the first data feed may include an initial data feed and then thereafter multiple, periodic data feeds from the employer host system 182, as employee data is updated and sent to the money transfer system 110 (e.g., updated weekly to add new employees).

At step 212, a second data feed is received at the money transfer system 110 from the offshore employer system 184, which in the described embodiment is on-board the ship. The data feed at step 212 relates to the ship where the system 184 is located, and includes data identifying the subset of employees that have been assigned that ship, data identifying the POS device 180 to be used for money transfers from the ship, and data identifying a message path or a portion of a path (over the Internet) for money transfer requests from the ship. Accordingly, in one embodiment, at step 212 the following information is sent for each employee assigned to the ship:
Employee ID
Ship ID
Device ID (IP address) for the device 180 on the ship
Path ID (IP addresses or range of IP addresses) for one or more points in the message path for money transfer requests from the ship.

In one embodiment, the second data feed is sent by system 184 near the departure date of the ship leaving port. Alternatively, the data feed could be sent in advance, but may include both the ship's date of departure and the ship's date of return to port.

The data received in the first and second data feeds is stored in the customer database 116. In one embodiment, the personal information in the first data feed, and the ship ID, device ID and path ID in the second data feed, are each stored in association with the employee ID of the employee to whom the information relates.

As mentioned earlier, the combination of device ID and message path ID will provide reliable data on the remote location from which a money transfer request is being made. A money transfer request that originates at the device 180 (as identified by its IP address) will provide assurance that the device 180 installed on the ship is being used for the request. The feature of using message path data will also provide assurance that the device is in a location (and using an authorized network and communications path) that has been authorized by the operator. Thus, given the mobile nature of the ship, only messages in paths recognized by the money transfer system will be regarded as authentic (eliminating risk from the POS device 180 somehow being removed from the ship or from a hacker obtaining the IP address and pretending to be the POS device 180 in order to conduct fraudulent transactions over a different message path). In an embodiment to be described later, the message path is defined by one or more IP addresses, such as a range of IP addresses for routers at a satellite system/network that is authorized to receive and route Internet data traffic from the assigned ship (a range of IP addresses may be used since the message may be received and passed through any one of a plurality of the routers at the satellite system). In some embodiments, only the point in the path defined by the router at the satellite system is used to verify location (since the location could be sufficiently verified based on it being sent through the authorized satellite). In other embodiments, additional points (beyond the satellite system) in the path over the Internet to the money transfer system 110 could also be used to verify location and path.

Finally in FIG. 2, a crew member/employee sends a money transfer request from the POS device 180 (while stationed on the ship) so that at the message is received at the money transfer system 110. The money transfer request will include (among other things) the ID for the crew member, an amount of the money transfer (as entered by the crew member at the device 180), the device ID (for POS device 180) that has been added to the message by the device 180, and one or more IP addresses for routers (or other points) in the path of the message that have been added to the message as the message passes through those points. The data received at step 214 is compared to the data previously received at steps 210 and 212, and if the data matches (e.g., sender ID, device ID and path ID), the message is regarded as having come from an authorized sender and location, and the transaction is processed by the money transfer system 110.

It should be appreciated that various risk assessments could be performed (e.g., by the risk assessment system 190) on the sender and on other transaction data apart from sender ID, device ID and path ID in the money transfer request received at step 214. For example, the risk assessment system 190 may perform a preliminary risk review on the sender (based on data received at step 210) and will perform a transaction-specific review on all the data associated with a money transfer transaction (after the sender and location have been verified, and based on information for the payee, the location of the payee, the amount of transaction and other available data received at step 214) using, for example, the methods mentioned earlier in connection with U.S. patent application Ser. No. 13/337,512.

While the simplified process of FIG. 2 is illustrated as having two different data feeds (step 210 and 212), it should be appreciated that in alternative embodiments, there may be only be a single data feed step, and in other embodiments, there may be more than two data feed steps. For example, the ship operator might only provide a single data feed (from only one of the employer host system 182 or the off-shore employer system 184). In such case, the single data feed step might include both data on all employees (similar to the data at step 210) and also data relating to specific ships to which crew members have been assigned, and the device ID and the path ID for that ship (similar to the data at step 212). As should be apparent, having two different data feeds (as in FIG. 2) permits more flexibility as crew member assignments change, and also permits some risk assessment steps to be undertaken even before a crew member assignments are known (the risk assessment system 190 may perform a risk assessment for all employees/crew members well in advance ship assignments and money transfer requests).

Also, while the first link in the communications path between the ship and the money transfer host 110 in the described embodiment is a satellite system, it should be appreciated that other types of wireless systems could be employed (e.g., microwave, cellular, etc.). In addition, depending on the nature of the remote location (off-shore or on land), various wire line communications systems could also be used (with the routers/points in the wire line systems appropriately identified).

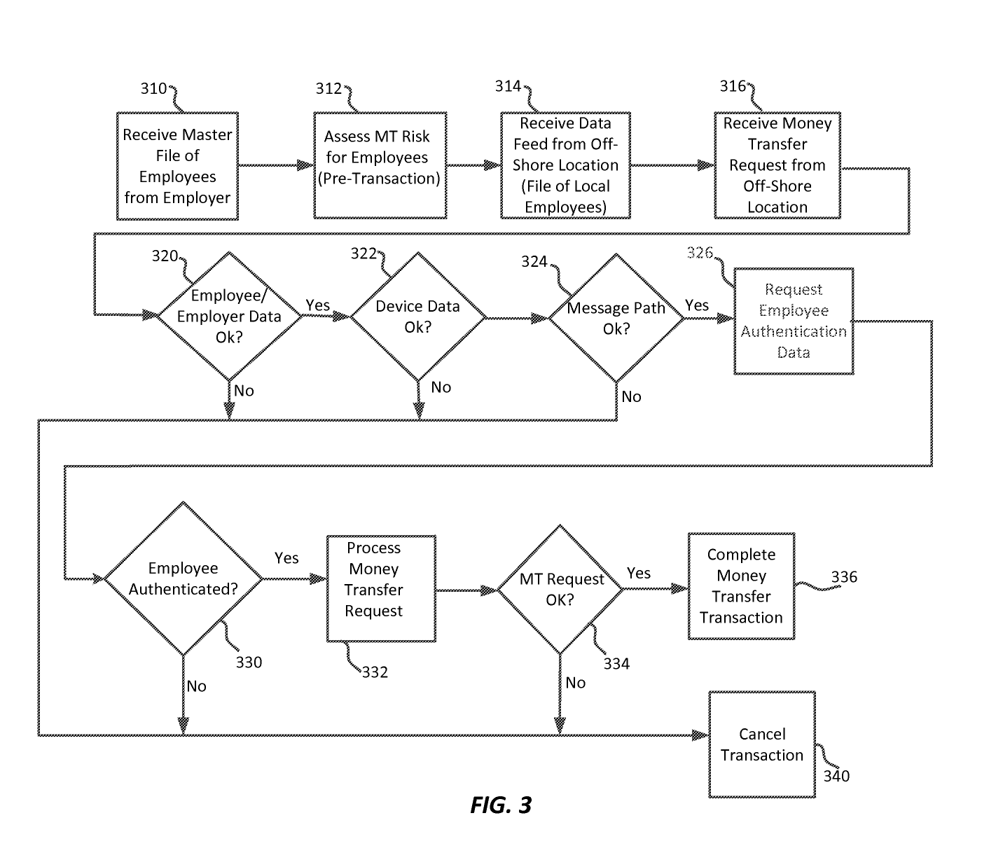

FIG. 3 illustrates a more detailed process for implementing the invention. As seen, at step 310 a first data feed (master file of employee data) is received by the money transfer system 110 from the employer host system 182 (such data may be stored in customer database 116). The data received in the master file is similar to the data described earlier in conjunction with step 210 in FIG. 2. At step 312, the money transfer system 110 preliminarily assesses the risk associated with potential money transfers by employees, based on the employee data received at step 310, such as employee ID (social security number), name, address, phone number, and so forth. While not seen in FIG. 3, a risk score could be calculated for each employee by risk assessment system 190 and that risk score may be stored at customer database 116 along with other employee information received at step 310. At step 314, a second data feed (files relating to local employees at specific remote locations/ships) is received at money transfer system 110 from the off-shore employer system 184, having data similar to the data described earlier in conjunction with step 212. Such data may likewise be stored (e.g., in in association with the individual employee to which it pertains) at customer database 116.

At step 316, a money transfer request is received at the money transfer host 110 from a remote location (e.g., an off-shore ship), and the data in the money transfer request is analyzed at steps 320, 322 and 324. At step 320, the employee/employer data is reviewed (e.g., the employee ID must match one of the employee IDs received at steps 310 and 314 and match the employer location (assigned ship ID) for that employee received at step 314. Also, if a sender has been previously assessed for risk (step 312), the transfer request may be rejected if the risk score is higher than permitted. Further, in some embodiments, other aspects of employee information may be checked, such as dates of departure and return of the ship to port (a money transfer request outside those dates would be suspect). Otherwise, the process continues to step 322 where the device data is checked (e.g., the device ID appended to the money transfer message matches the device ID associated with the employee's ship). If the data is accepted at step 322, then the message path appended to the request message is checked at step 324, and if accepted (it matches the authorized message path for the ship previously provided at step 314), the processing proceeds.

If data is not acceptable at any of the steps 320, 322 and 324, the processing stops and the transaction is cancelled at step 340.

At step 326, the employee is requested to provide authentication data. For example, the employee may be required to enter a password. While not illustrated in FIG. 3, an employee may be required to register with the money transfer service prior to conducting any money transfers, and an employee password (and other personal information) may be established as part of that registration.

If the employee is properly authenticated (step 330), the money transfer request is processed at step 332. If not authenticated, the transaction is cancelled (step 340). It should be appreciated that the process as thus far described is largely directed to verifying the sender ID, device ID, and path ID (i.e., the money transfer service confirms that the request has come from an authorized employee, that the request originates at an authorized device 180, and that the request message has passed through the proper path from the remote location (ship) to the money transfer system 110. In the processing of the request at step 332, the money transfer host may evaluate other aspects of the request to determine risk and decide at step 334 whether or not to permit the money transfer request to be completed (e.g., based on risk data associated with the specific payee, the location of the payee, the amount of the transaction, and so forth—see, for example, risk assessment described in aforementioned U.S. Application No. 13/337,512). If all the data associated with the money transfer request is accepted (step 334), then the money transfer transaction is completed at step 336, and money is transferred, e.g., the amount of the transfer is debited from the employee's account, and that amount (less any transfer fees) is credited to a payee's account or sent to an agent location where the payee may pick up the transferred amount in cash, check, etc.

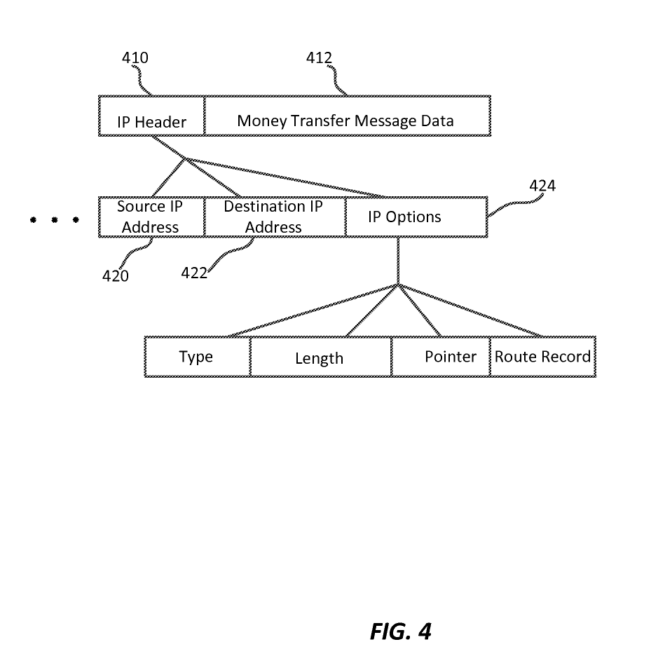

FIG. 4 illustrates the format of a money transfer request message sent from a remote location (e.g., an off-shore ship) to the money transfer host 110, such as the request received at step 316. The message is formatted in accordance with a standard Internet protocol, such as IPv4 or IPv6, as described at the Internet Engineering Task Force (IETF) publications RFC 791 (September 1981) and RFC 2460 (December 1998). A general discussion of IP packet structure can also be found in an article entitled “IPv4,” at www.wikipedia.org/wiki/IPv4, which is hereby incorporated by reference.

As seen, the message packet includes a header portion (IP header) 410 and a data portion (money transfer message data) 412. The header portion 410 contains data concerned with the management and transmission of the packet, and the data portion 412 contains data to be delivered to the destination (e.g., standard money transfer data such as sender ID, payee ID, transfer amount and so forth).

The IP header includes (among other things) standard fields illustrated in FIG. 4 as Source IP Address field 420, Destination IP Address field 422, and IP Options field 424. The Source IP Address is the address of the originating device/system from which the message is sent over the Internet (in the described embodiment, the off-shore POS device 180), and the Destination IP Address is the IP address of the destination device/system to which the message is to be delivered over the Internet (in the described embodiment, a network interface at the money transfer system 110). The IP Options field is a standard field used in IPv4 and IPv6 for optional data (beyond the typical header data). In the described embodiment, the IP options field is set at IP Option 7, which causes the packet to record the route of the message as it travels over the Internet. The IP Options field 424 is shown in FIG. 4 as including sub-fields identified as “Type,” “Length,” “Pointer,” and “Route Record.” Such fields are described in detail in the previously-referenced publication RFC 791 and in an article entitled “RFC Sourcebook, Description of IP Option 7,” at www.networksorcery.com/enp/protocol/ip/option007.htm, which is hereby incorporated by reference.

The “Type” field is set to 7 to indicate that the route or message path is to be tracked or recorded. The “Length” field specifies the total length (size) of the IP Options field 424. For example, the money transfer service may establish a length that dictates how many path points must be captured as the message travels over the Internet, to be compared to a known message path at step 324. The “Pointer” field points to the byte in the Route Record field into which the next path point identifier (IP address) is to be stored as the message arrives at each point in the path.

The use of the IP Options field, and including its use in determining the topography (and path points) of a specific network path over which an IP message packet travels, is known (see, e.g., U.S. Pat. No. 7,602,728, issued to Adhikari et al on Oct. 13, 2009, which is hereby incorporated by reference).

In the described embodiment, the IP Options field is used to track at least a portion of the path that a money transfer request message from the off-shore POS device 180 travels to reach the money transfer system 110, and thereby confirm the location of the device 180 (by determining which path it uses after leaving the device 180). In one embodiment, only the first point in the path is used to confirm location, the first point being a router on a satellite to which Internet messages from the off-shore location (ship) are transmitted. This would enable the money transfer host 110 to determine that the device 180 is at an expected location transmitting to the authorized satellite, and if not transmitting to that satellite (but rather travelling through a different path), that the device 180 is not at its proper location or has been hacked into by a third party using a different path to reach the money transfer host 110).

It should be appreciated that in other embodiments additional points in the path identified in the IP Options field could be used (tracked in the IP Options field) to provide a more complete path over which the money transfer request message has been sent to reach the money transfer host 110.

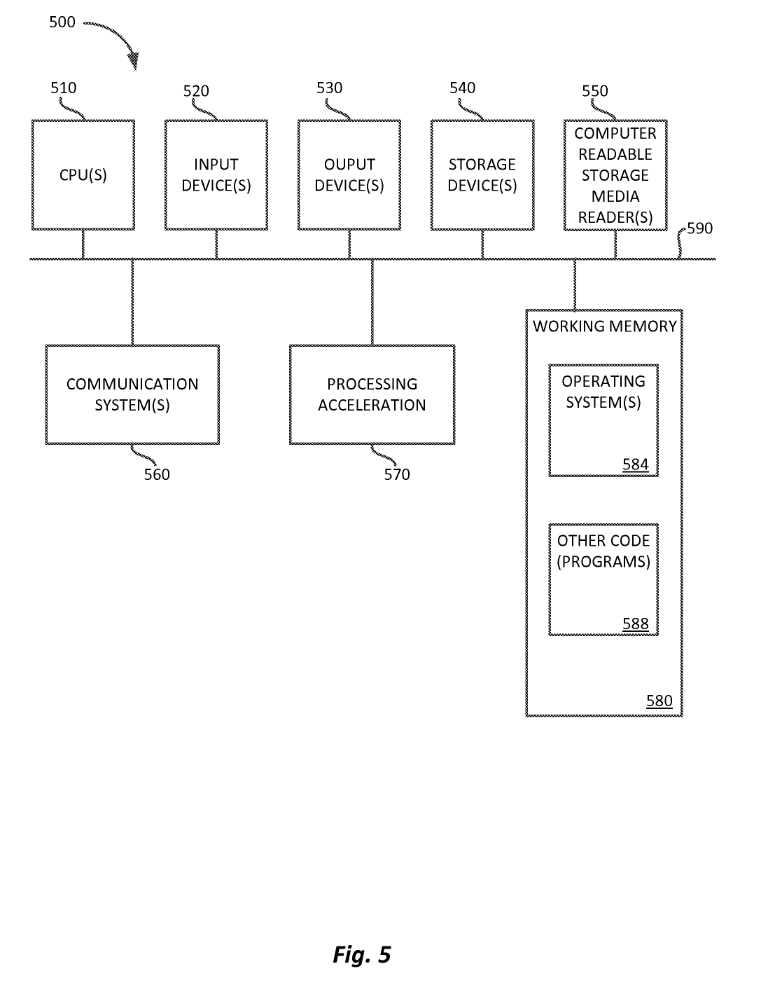

FIG. 5 is a block diagram illustrating an exemplary computer system upon which embodiments of the present invention may be implemented. This example illustrates a computer system 500 such as may be used, in whole, in part, or with various modifications, to provide the functions of the money transfer host system 110, off-shore POD device 180, employer host system 182 and off-shore employer system 184, as well as other components and functions of the invention described herein.

The computer system 500 is shown comprising hardware elements that may be electrically coupled via a bus 590. The hardware elements may include one or more central processing units 510, one or more input devices 520 (e.g., a mouse, a keyboard, etc.), and one or more output devices 530 (e.g., a display device, a printer, etc.). The computer system 500 may also include one or more storage devices 540, representing remote, local, fixed, and/or removable storage devices and storage media for temporarily and/or more permanently containing computer-readable information, and one or more storage media reader(s) 550 for accessing the storage device(s) 540. By way of example, storage device(s) 540 may be disk drives, optical storage devices, solid-state storage device such as a random access memory (“RAM”) and/or a read-only memory (“ROM”), which can be programmable, flash-updateable or the like.

The computer system 500 may additionally include a communications system 560 (e.g., a modem, a network card—wireless or wired, an infra-red communication device, a Bluetooth™ device, a near field communications (NFC) device, a cellular communication device, etc.) The communications system 560 may permit data to be exchanged with a network, system, computer, mobile device and/or other component as described earlier. The system 500 also includes working memory 580, which may include RAM and ROM devices as described above. In some embodiments, the computer system 500 may also include a processing acceleration unit 570, which can include a digital signal processor, a special-purpose processor and/or the like.

The computer system 500 may also comprise software elements, shown as being located within a working memory 580, including an operating system 584 and/or other code 588. Software code 588 may be used for implementing functions of various elements of the architecture as described herein. For example, software stored on and/or executed by a computer system, such as system 500, can be used in implementing the processes seen in FIGS. 2 and 3.

It should be appreciated that alternative embodiments of a computer system 500 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example mentioned earlier, the money transfer host system 110 may be implemented by a single system having one or more storage device and processing elements. Alternatively, the money transfer host system 110 may be implemented by plural systems, with their respective functions distributed across different systems either in one location or across a plurality of linked locations.

Moreover, while the various flows and processes described herein (e.g., those illustrated in FIGS. 2 and 3) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for conducting an on-line money transfer that is requested at a remote location, comprising:
receiving data, in advance of a money transfer request and at a money transfer host computer, relating to money transfers at the remote location, the received data including at least a device ID that identifies a user device at the remote location, and a path ID that identifies one or more points in a path through which a message requesting a money transfer is to be electronically communicated from the remote location;
storing the device ID and the path ID received in advance of a money transfer request;
receiving, at the money transfer host computer, a transmitted message from the remote location requesting a money transfer, the transmitted message including at least a transmitted device ID of an originating user device at which the money transfer is requested and a transmitted path ID of one or more points in a path through which the transmitted message passes from the originating user device to the money transfer host computer;
comparing the transmitted device ID and transmitted path ID to the stored device ID and stored path ID; and
processing the received money transfer request if the transmitted device ID and transmitted path ID match the stored device ID and stored path ID.

2. The method of claim 1, wherein the step of receiving data in advance of a money transfer request further comprises receiving a sender ID for each of a plurality of potential senders and receiving an account ID of an account into which money is provided for each of the potential senders by a trusted funds source, wherein the step of storing further comprises storing the sender ID and account ID in association with the stored device ID and the stored path ID, and wherein the step of receiving a transmitted message further comprises receiving a remote sender ID of a sender at the remote location.

3. The method of claim 2, wherein the account is an account established for each of the potential senders by the trusted funds source.

4. The method of claim 3, wherein the trusted funds source is an employer, wherein employees of the employer are the potential senders, and wherein the employer deposits paycheck funds into the account.

5. The method of claim 4, wherein the remote location is on an off-shore ship, and wherein the employees are crew members assigned to the off-shore ship.

6. The method of claim 5, wherein the employer is the operator of the off-shore ship.

7. The method of claim 1, wherein the step of receiving data in advance of a money transfer request further comprises receiving a first data feed and a second data feed, wherein the first data feed comprises (1) personal information for each of a plurality of potential senders and (2) account information for an account into which money has been deposited by a trusted funds source for each of the plurality of potential senders, and wherein the second data feed comprises the device ID and the path ID.

8. The method of claim 7, wherein the personal information comprises a sender ID, wherein the device ID comprises an IP address for the user device, and wherein the path ID comprises an IP address of a network device receiving the transmitted message from the user device.

9. The method of claim 8, wherein the network device is a router at a satellite system receiving Internet communications from the user device.

10. The method of claim 7, wherein the trusted funds source is an employer, wherein the potential senders are employees of the employer, wherein the first data feed is received from an employer host system and the personal information received from the employer host system relates to employees of the employer.

11. The method of claim 10, wherein the second data feed is received from a remote employer system at the remote location, and wherein the second data feed further comprises personal information associated with employees assigned to the remote location.

12. The method of claim 11, wherein the remote location is an off-shore ship, wherein the employer operates the ship, wherein the employees assigned to the remote location are crew members of the ship, wherein the user device is located on the ship, and wherein the path ID is an IP address for a router at a satellite system that receives communications from the ship.

13. The method of claim 7, wherein the money transfer host includes a risk assessment system that assesses a risk associated with money transfers based on the personal information for each of the potential senders in the first data feed, prior to receiving the message requesting a money transfer.

14. A method for conducting an on-line money transfer transaction by a sender from a remote location, the method comprising:
establishing, by a trusted funds source, a plurality of accounts into which funds are deposited by the trusted funds source, each of the accounts set up for the benefit of at least one of a plurality of potential senders;
receiving, at a money transfer host computer from or on behalf of the trusted funds source, a first data feed having data for potential senders, the first data feed including at least a sender ID for each potential sender, and an account ID of an account into which money is deposited by the trusted funds source for each potential sender;
receiving, at the money transfer host computer from the remote location, a second data feed having data on potential senders at the remote location, the received data including at least a sender ID for each potential sender at the remote location, a device ID that identifies a user device for use by each potential sender at the remote location to initiate money transfer requests, and a path ID that identifies one or more points in a path through which a money transfer request may be electronically communicated from the user device at the remote location;
storing, in association with the received sender ID for each potential sender, the received account ID, the received device ID, and the received path ID;
receiving, at the money transfer host computer, a transmitted message from the remote location requesting a money transfer, the transmitted message including at least a transmitted sender ID for the sender requesting the money transfer, a transmitted device ID of a user device at which the money transfer is requested, and a transmitted path ID of one or more points in a path through which the transmitted message passes from the user device to the money transfer host computer;
comparing, for the transmitted sender ID corresponding to a stored sender ID, the transmitted device ID and transmitted path ID of the transmitted sender ID to the stored device ID and stored path ID of the corresponding stored sender ID; and
processing the money transfer request if the stored device ID and stored path ID match the transmitted device ID and transmitted path ID.

15. The method of claim 14, wherein the remote location is at an off-shore ship, wherein the trusted funds source is an employer, wherein the potential senders are employees of the employer, and wherein the potential senders at the remote location are employees of the employer that have been assigned as crew members to the off-shore ship.

16. A system, comprising:
a processor; and
a memory communicatively connected with and readable by the processor, the memory containing instructions that, when executed by the processor, cause the processor to perform the money transfer, by:
receiving, in advance of a money transfer request, data on potential senders at the remote location, the data including at least a device ID that identifies a user device at the remote location where money transfers are requested, and a path ID that identifies one or more points in a path through which a message requesting a money transfer is electronically communicated from the remote location to a money transfer host computer;
storing the device ID and the path ID received in advance of a money transfer request;
receiving, at the money transfer host computer, a transmitted message from the remote location requesting a money transfer, the transmitted message including at least a transmitted device ID of a user device at which the money transfer is requested and a transmitted path ID of one or more points in a path through which the transmitted message passes from the user device to the money transfer host computer;
comparing the transmitted device ID and transmitted path ID to the stored device ID and stored path ID; and
processing the money transfer request if the stored device ID and stored path ID match the transmitted device ID and transmitted path ID.

17. The system of claim 16, wherein the memory further contains instructions that, when executed by the processor, cause the processor to perform the money transfer, by:
receiving a sender ID for each of a plurality of potential senders and receiving an account ID of an account into which money is provided for each of the potential senders by a trusted funds source;
storing the sender ID and account ID in association with the stored device ID and the path ID; and
receiving a remote sender ID of a sender at the remote location when receiving the transmitted message requesting a money transfer.

18. The system of claim 17, wherein the account is an account established for each of the potential senders by the trusted funds source.

19. The system of claim 18, wherein the trusted funds source is an employer, wherein employees of the employer are the potential senders, and wherein the employer deposits paycheck funds into the account.

20. The system of claim 19, wherein the remote location is on an off-shore ship, and wherein the employees are crew members assigned to the off-shore ship.

21. The system of claim 20, wherein the employer is the operator of the off-shore ship.

22. The system of claim 16, wherein the memory further contains instructions that, when executed by the processor, cause the processor to perform the money transfer, by:
receiving a first data feed and a second data feed, wherein the first data feed comprises (1) personal information for each of a plurality of potential senders and (2) account information for an account into which money has been deposited by a trusted funds source for each of the plurality of potential senders, and wherein the second data feed comprises the device ID and the path ID.

23. The system of claim 22, wherein the personal information comprises a sender ID, wherein the device ID comprises an IP address for the user device, and wherein the path ID comprises an IP address of a network device receiving the transmitted message from the user device.

24. The system of claim 23, wherein the network device is a router at a satellite system receiving Internet communications from the user device.

25. The system of claim 22, wherein the trusted funds source is an employer, wherein the potential senders are employees of the employer, wherein the first data feed is received from an employer host system and the personal information received from the employer host system relates to employees of the employer.

26. The system of claim 25, wherein the second data feed is received from a remote employer system at the remote location, and wherein the second data feed further comprises personal information associated with employees assigned to the remote location.

27. The system of claim 26, wherein the remote location is an off-shore ship, wherein the employer operates the ship, wherein the employees assigned to the remote location are crew members of the ship, wherein the user device is located on the ship, and wherein the path ID is an IP address for a router at a satellite system that receives communications from the ship.

28. The system of claim 22, wherein the money transfer host includes a risk assessment system that assesses a risk associated with money transfers based on the personal information for each of the potential senders in the first data feed, prior to receiving the message requesting a money transfer.

29. A money transfer system for conducting an on-line money transfer transaction by a sender from a remote location, comprising:
one or more employer systems; and
a money transfer host, including a database, operated by a money transfer service,
wherein the money transfer host receives from the employer systems at least one data feed having data on employees that are potential money senders, the received data feed comprising a sender ID for each potential sender, an account ID of an account into which money is deposited by an employer for each potential sender, a device ID of a user device for use by each potential sender at the remote location to initiate money transfer requests, and a path ID that identifies one or more points in a path through which a money transfer request may be electronically communicated from the user device at the remote location;
wherein the sender ID, the account ID, the device ID, and the path ID in the received data feed are stored in the database;
wherein the money transfer host receives a money transfer request in a message transmitted from the remote location, the message including at least a transmitted device ID of a device from which the money transfer request message originates and a transmitted path ID of one or more of a plurality of points in a path from which the message is electronically communicated;
wherein the money transfer host compares the transmitted device ID and transmitted path ID to the device ID and the path ID stored in the database; and
wherein the money transfer host processes the money transfer request if the transmitted device ID and transmitted path ID match the device ID and the path ID stored in the database.
